(19) United States
(12) Patent Application Publication
(10) Pub. No.: US 2014/0222529 A1
(43) Pub. Date: Aug. 7, 2014

(54) METHOD AND SYSTEM FOR ONLINE MARKETING WITH CONSUMER PARTICIPATION

(71) Applicant: Kyle VanderLugt, Rockville, MD (US)

(72) Inventor: Kyle VanderLugt, Rockville, MD (US)

(21) Appl. No.: 13/758,459

(22) Filed: Feb. 4, 2013

(51) Int. Cl. G06Q 30/02

(52) U.S. Cl. CPC G06Q 30/0276
USPC 705/12; 705/14.72

(57) ABSTRACT

A method and system comprise communicating with a computer system configured to host marketing media from at least one producer and marketing expert. Marketing media is received for a product to be viewed by a consumer. The marketing media comprises a solicitation for an advertising contest. At least one consumer media is produced by the consumer in response to the solicitation. The system stores the consumer media in a first database for approval by the producer and marketing expert. An approval of the consumer media is received for further approval by the consumer for public viewing. The approval by the consumer for public viewing is transferred to the system. The approved consumer media is stored in a second database viewable and searchable by the public. Viewing of the consumer media at least in part determines an outcome of the advertising contest.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to online marketing. More particularly, the invention relates to online marketing with consumer participation.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that marketing is the process of communicating the value of a product or service to customers. Marketing might sometimes be interpreted as the art of selling products, but selling is only a small fraction of marketing.

Typically, marketing may rely on various technologies within the scope of the marketing effort. Computer-based information systems may be employed, aiding in better processing and storage of data. Marketing researchers may use such systems to devise better methods of converting data into information, and for the creation of enhanced data gathering methods. Information technology may also serve to improve a company's marketing decision-making process.

Typically, consumer contest entrants enter to win a prize, hence many entrants are all in competition, or competing for a limited number of prizes. A trade promotion competition is a free entry lottery run to promote goods or services supplied by a business. An example may include purchasing goods or services and then entering into a lottery to possibly win a prize.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a flowchart detailing exemplary steps in an exemplary marketing method, in accordance with an embodiment of the present invention;

FIGS. 2A, 2B, 2C, 2D, 2E, 2F, 2G, 2H, 2I, and 2J illustrate an exemplary marketing system and method functioning on a dedicated platform, in accordance with an embodiment of the present invention, where FIG. 2A illustrates the identification of new customers through various queries and questionnaires, FIG. 2B illustrates the solicitation of an exemplary customer to the consumer for participation in an exemplary advertisement contest through various polls, FIG. 2C illustrates an exemplary customer initiating an exemplary advertising contest, FIG. 2D illustrates an exemplary login page for participating in an exemplary advertising contest, FIG. 2E illustrates an exemplary terms and conditions form generated for participating in an exemplary advertisement contest, FIG. 2F illustrates an exemplary consumer submitting an exemplary video advertisement, FIG. 2H illustrates processing and analyzing of exemplary consumer media, FIG. 2G illustrates exemplary consumer media stored on an exemplary media storage portion, FIG. 2I illustrates a graphical representation of consumer media that an exemplary customer may accept or decline for public viewing, and FIG. 2J illustrates a plurality of consumer media that are marked as accepted or denied for public viewing, in accordance to an embodiment of the present invention;

FIG. 3 illustrates a typical computer system that, when appropriately configured or designed, may serve as an exemplary marketing method and system, in accordance with an embodiment of the present invention; and

FIG. 4 illustrates an exemplary marketing system, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

The present invention will now be described in detail with reference to embodiments thereof as illustrated in the accompanying drawings.

There are various types of marketing methods and systems that may be provided by preferred embodiments of the present invention. In one embodiment of the present invention, the marketing method and system may allow a producer to integrate a consumer with the production and analysis of marketing media for a product. The inclusion of the consumer in marketing the product may be incentivized through an advertising contest. Including the consumer in the marketing effort may reduce marketing production costs for the customer while also providing the producer a better understanding of consumer demands for the product. The consumer may find the desired product or service to activate the marketing method on a dedicated platform for marketing contests, via the customer's web properties, and/or social media sites.

In one embodiment of the present invention, the marketing method may include an initial Step of a producer and a marketing expert distributing marketing media for a product. The marketing media may include advertising contests for a product that the producer solicits. The marketing media may also include customer merchandise offers, written target audience profiles or online audience profiles. In some embodiments, the distribution of marketing media may require identifying a consumer who may potentially be interested in obtaining the product. The consumer may then view and select the desired marketing media for viewing and response. In a second Step, the consumer may view and respond to the marketing media. In some embodiments, the consumer may register and agree to terms and conditions prior to participating in the advertising contests. In this manner, additional information about the consumer may be obtained, and the consumer may be made more aware about the product. The consumer may provide various inputs, including, without limitation, responses, suggestions, reviews, and requests for the marketing media. The input may be transmitted to a data storage portion viewable by the producer, the consumer, and the marketing expert. In a third Step, the consumer may produce a consumer media in response to the marketing media. The consumer media may include a video advertisement operable to compete in the advertising contest. In some embodiments, the consumer media may include a video for a short commercial containing a message that pertains to the product. However, in other embodiments, the video may include, without limitation, pictures, text, music, and graphics. Those skilled in the art, in light of the present teachings, will recognize that the competitive nature of the advertising contest may incentivize the consumer to produce new and novel consumer media, whereby the producer may further understand the consumer's preferences and also utilize the consumer media for free advertisement. By allowing the consumer to produce the consumer media, the time, skill sets, and associated costs of generating advertising content is shifted from the producer to the consumer. In some embodiments, prior to producing the consumer media, the consumer may generate a consumer profile. The consumer profile may allow the producer and the marketing expert to better understand the demographics of the consumer, and also access the consumer through various means, including, without limitation, email, social media sites, telephone, and postal mail. A fourth Step may include analyzing the consumer media by the producer and the marketing expert. In some embodiments, a media storage portion may serve to link the producer, the consumer, and the marketing expert in an online forum to allow for exposure and expert review of the consumer media. In some embodiments, the context in which the consumer media may be reviewed may include multi-stage contests which may include consumer reviews. The analysis may include, without limitation, gathering marketing information about the consumer and judging the advertising contest. In some embodiments, the advertising contests may be decided on a range of criteria based on content, purpose, and entertainment value. In a fifth Step, the consumer media may be approved for appropriateness and legal liability prior to displaying publicly. In some embodiments, the consumer media may be viewed for appropriateness and then submitted to a consumer profile page whereby the consumer media may be viewed in a second media storage portion in which the consumer approves the consumer media that may be uploaded to an internet for public viewing. In this manner, the consumer media may satisfy legal terms and conditions before being uploaded for public viewing. A final Step may include distributing the consumer media for public viewing. The producer may increase the content exposure and distribution of the consumer media through various media channels, including, without limitation, internet social media, internet sites, television, and radio. In some embodiments, the consumer media may include a conglomeration of videos submitted in response to advertising based contests. In one embodiment, a dedicated platform may allow the producer and the marketing expert to generate, view, and share consumer media from multiple contests.

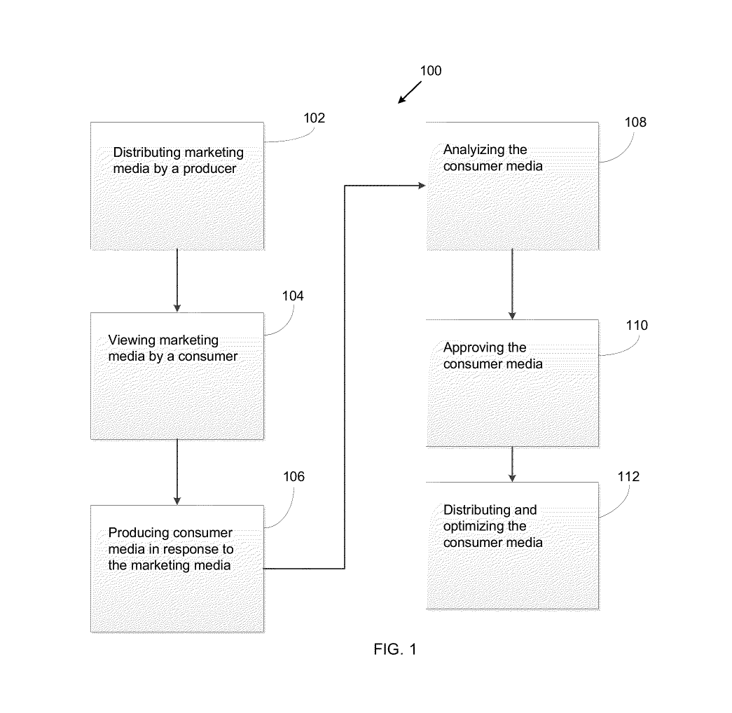

FIG. 1 illustrates a flowchart detailing exemplary steps in an exemplary marketing method, in accordance with an embodiment of the present invention. In the present invention, the marketing method and system 100 may allow a producer to involve a consumer in the production and analysis of marketing media. The consumer may view marketing media through a social site on the internet, and respond by producing a consumer media that is pertinent to the product. The consumer media may then be reviewed and distributed by the producer and a marketing expert. In some embodiments, the inclusion of the consumer in marketing a product may reduce marketing production costs for the producer while also providing the producer a better understanding of consumer demands for the product.

In one embodiment of the present invention, the marketing method may include an initial Step 102 of a producer and a marketing expert distributing marketing media for a product. The marketing media may include video advertisements directed towards a social site. The video advertisement may include, without limitation, graphics, music, pictures, drawings, and sounds configured to promote the product. In some embodiments, the marketing system and method may include a dedicated platform for hosting videos. The social site may include, without limitation, facebook, youtube, yelp, buzzfeed, Stumbleupon, and twitter. In some embodiments, the marketing media may include an advertising contest that promotes or provides information on a product or service that the producer solicits. The advertising contests may be utilized for myriad products, services, or events. For example, without limitation, the contests may address financial advice, including, without limitation, what are the best stocks right now, what are best CDs, what is the best IRA conditions, what is the best home mortgage rates. The contests may further address home improvements, including, without limitation, which renovation to select, and which material to select. The contests may further address dating issues, including, without limitation, which guy/girl to select, tall and good looking or short and rich, dating Jewish or Christian? rich or poor? blond or brunette? The contests may further address the hiring of candidates in which consumers post their resumes for public review. This would set up a database of online resumes with a voting system by recruiting firms or general public to indicate strength of those individuals relative to job opportunities. The contest may further address the naming of a product or the creation of a mascot or theme song. In some embodiments, the distribution of marketing media may require identifying a consumer who may potentially be interested in obtaining the product. The consumer may then view and select the desired marketing media for viewing and response. In one alternative embodiment, the distribution of the marketing media may be accomplished on mobile technology, including, without limitation, mobiles phone, iphone, android, and blackberry.

In one embodiment of the present invention, a second Step 104 may include the consumer viewing the marketing media received from the producer. In some embodiments, the consumer may register and agree to terms and conditions prior to participating in the advertising contests. The terms and conditions form may specify the contest rules including the understanding that the consumer is responsible for the uniqueness of the marketing media and that the consumer does not violate any federal, state, or business laws. The terms and conditions also states the criteria for generating the media content including product placement and the stating of producer services. In this manner, additional information about the consumer may be obtained, and the consumer may be made more aware about the product. The consumer may provide various inputs, including, without limitation, responses, suggestions, reviews, and requests for the marketing media. The input may be transmitted to a data storage portion viewable by the producer, the consumer, and the marketing expert. The data storage portion may include, without limitation, a graphic database, a server, and a microchip.

In one embodiment of the present invention, a Step 106 may include the consumer producing consumer media in response to the marketing media. The consumer media may include a video advertisement operable to compete in the advertising contest. A custom front-end interface may allow the consumer to submit the consumer media. For example, without limitation, the marketing method may include software that automatically converts submitted consumer media to a single audiovisual format, whereby allowing audiovisual material to be automatically linked together. This formatting may allow a short advertising clip of the product to be automatically added in front of short video graphic advertising segments This formatting may also allow for a short advertising clip or banner to appear in the consumer media promoting the company as the dedicated platform for these kinds of advertising contests. In some embodiments, the consumer media may include an advertising video for a short commercial containing a message that pertains to the product. However, in other embodiments, the video may include, without limitation, pictures, text, music, and graphics. Those skilled in the art, in light of the present teachings, will recognize that the competitive nature of the advertising contest may incentivize the consumer to produce new and novel consumer media, whereby the producer may further understand the consumer's preferences and also utilize the consumer media for free advertisement. By allowing the consumer to produce the consumer media, the time, skill sets, and associated costs of generating advertising content is shifted from the producer to the consumer. In some embodiments, prior to producing the consumer media, the consumer may generate a consumer profile. The consumer profile may allow the producer and the marketing expert to better understand the demographics of the consumer, and also access the consumer through various means, including, without limitation, email, social media sites, telephone, and postal mail. The consumer profile may allow the company to build a master database of consumers with varying demographics for future advertising contests with a wide variety of producers.

In one embodiment of the present invention, a Step 108 may include the producer and the marketing expert analyzing the consumer media for appropriate content. The producer and marketing expert are looking for consumer media which is compelling to the broader population of consumers, which has the greatest chance of gaining mass exposure and creating an internet meme. The consumer media could be shocking and/or more edgy and bold than more traditional producer media or not. The producer and marketing expert are also looking for consumer media which is consistent with the values the producer stands for. In some embodiments, the consumer media may store on a dedicated website portal for viewing by the producer. A media storage portion may serve to link the producer, the consumer, and the marketing expert in an online forum to allow for exposure and expert review of the submitted consumer media. In some embodiments, the context in which the consumer media may be reviewed may include multi-stage contests capable of supporting consumer reviews. The analysis may include, without limitation, gathering marketing information about the consumer and judging the advertising contest. In some embodiments, the advertising contests may be decided on a range of criteria based on content, purpose, and entertainment value. In some embodiments, the advertising contests may be decided on a range of criteria based on number of views, success in social media, and a wide variety of the digital analytics data points for a particular consumer media. A point system may be utilized to reward the consumer for a winning consumer media. In some embodiments, the points may be accumulated to receive prizes, including, without limitation, free products, cash, badges, vouchers, and discounts.

In one embodiment of the present invention, a Step 110 may include the producer and the marketing expert approving the consumer media for appropriateness and legal liability prior to displaying publicly. In some embodiments, the consumer media may be viewed for appropriateness and then submitted to a consumer profile page whereby the consumer media may be viewed in a second media storage portion in which the customer approves the consumer media that may be uploaded to the internet for public viewing. In this manner, the consumer media may satisfy legal terms and conditions before being uploaded for public viewing.

In one embodiment of the present invention, a Step 112 may include distributing the consumer media for public viewing. In some embodiments, the producer may increase the content exposure and distribution of the consumer media through various media channels, including, without limitation, internet social media, internet sites, television, and radio. In some embodiments, the consumer media may include a conglomeration of videos submitted in response to advertising based contests. In one embodiment, a dedicated platform may allow the producer and the marketing expert to generate, view, and share consumer media from multiple contests. In one alternative embodiment of the present invention, a business may access the network of community consumers by generating a contest as a producer. In yet another alternative embodiment, the marketing may include auditory marketing designed for the radio, whereby the consumer may submit audible entries for the advertising contest. In yet another alternative embodiment, the consumer may receive digital rewards for submitting an entry and/or winning the advertising contest.

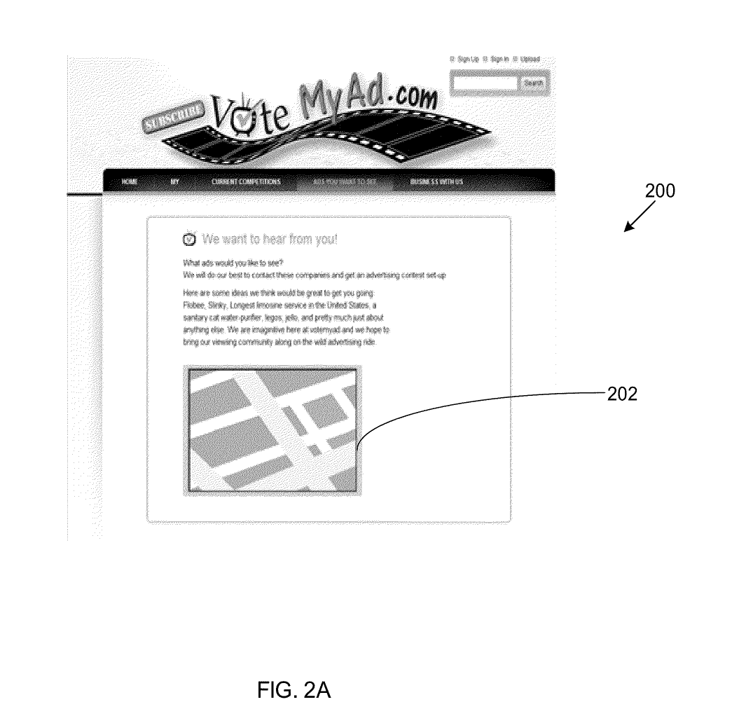

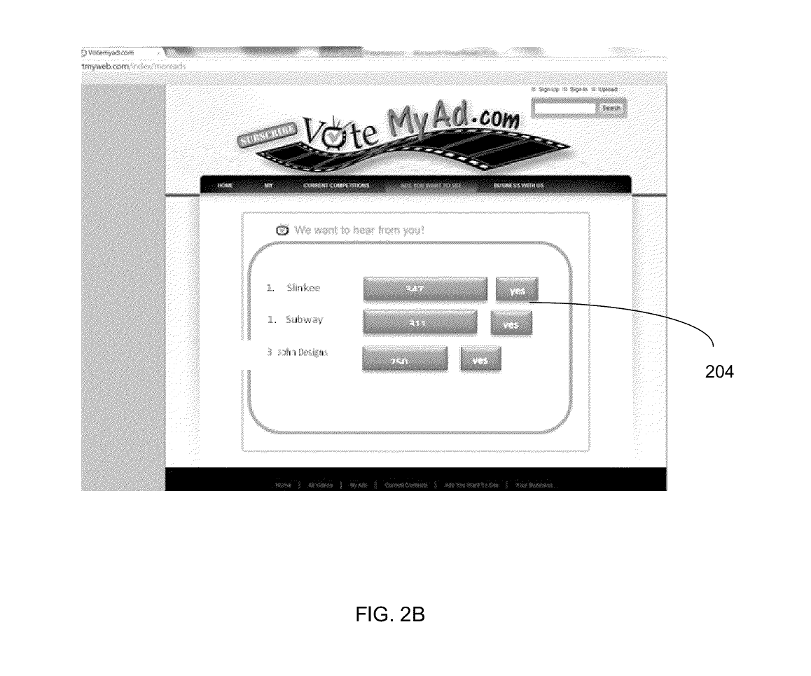

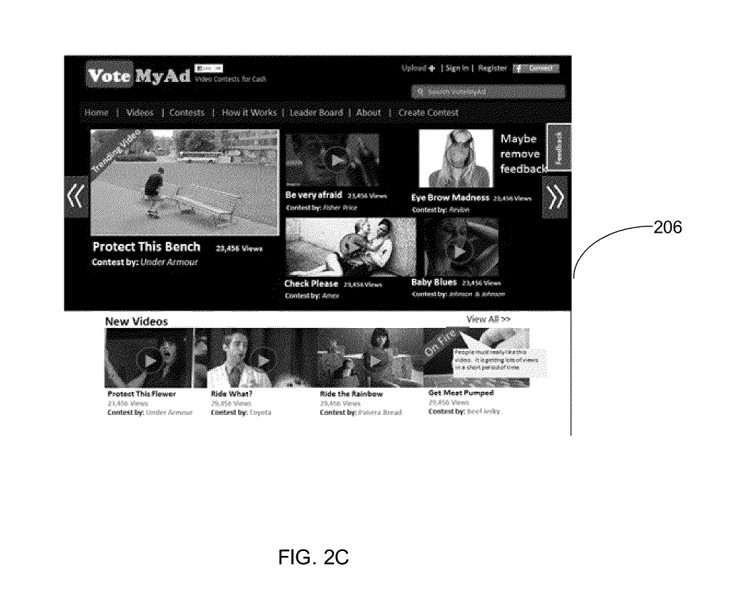

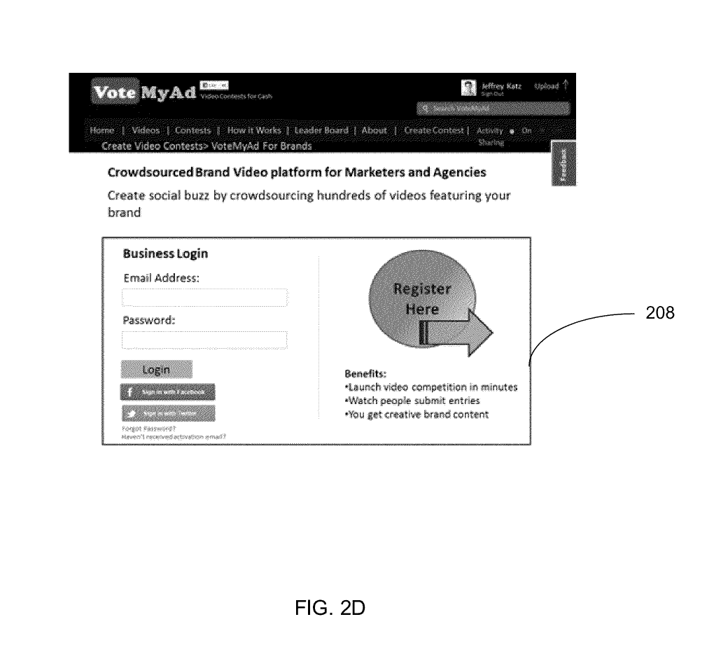

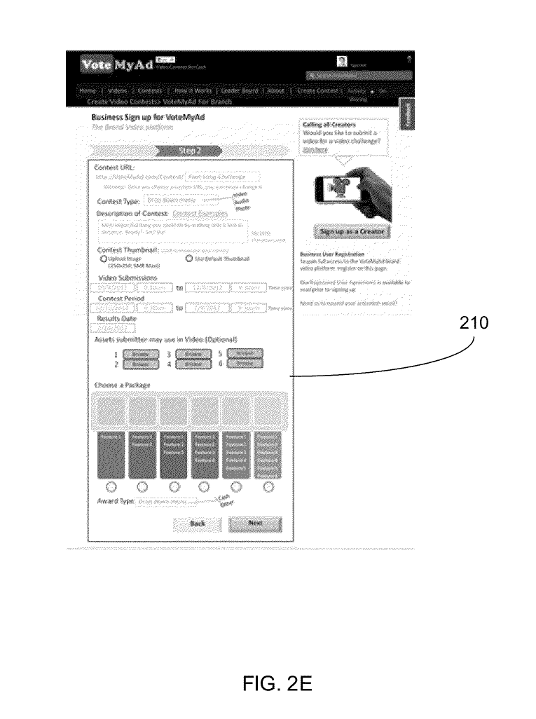

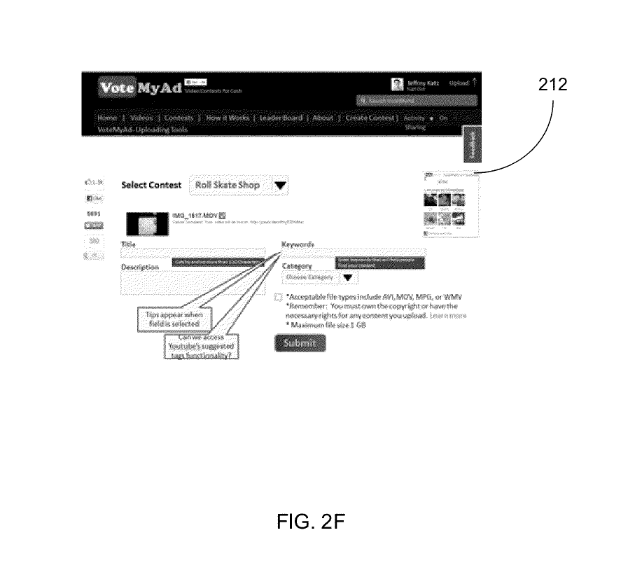

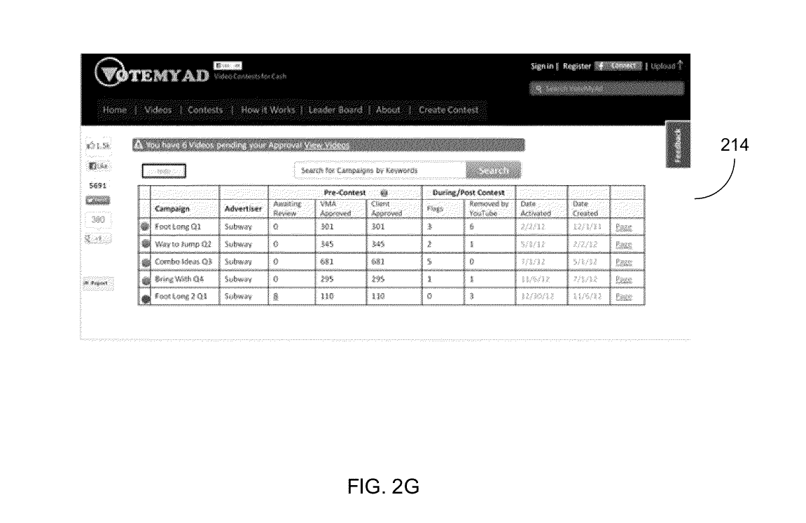

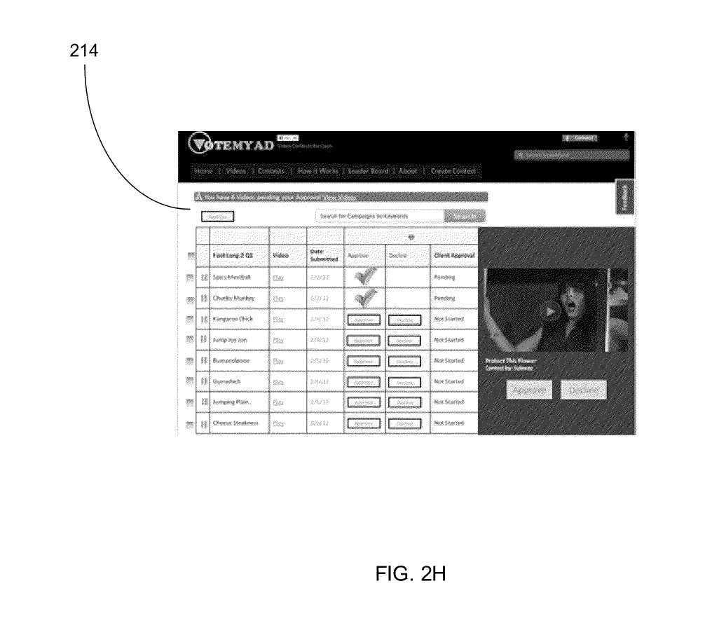

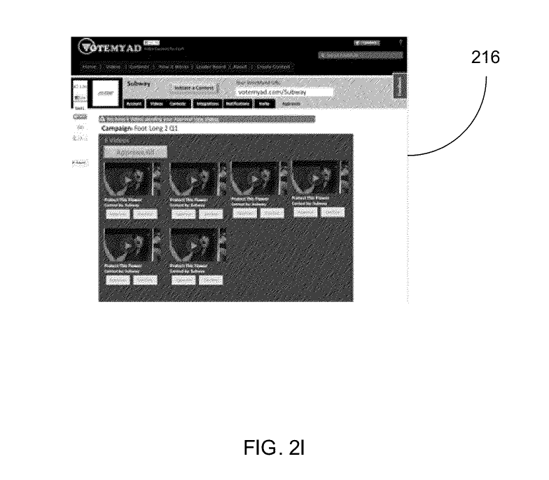

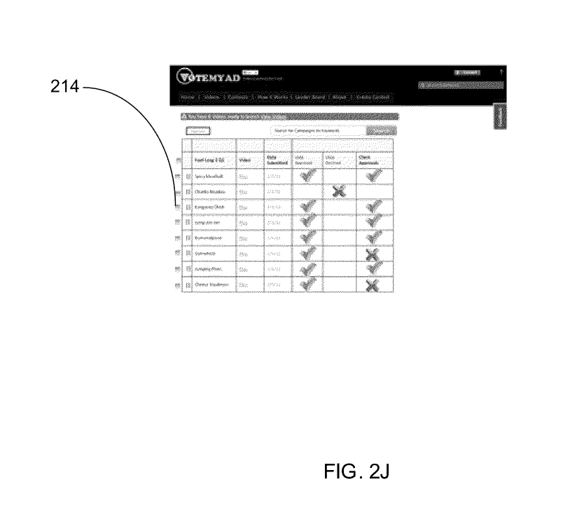

FIGS. 2A, 2B, 2C, 2D, 2E, 2F, 2G, 2H, 2I, and 2J illustrate an exemplary marketing system and method functioning on a dedicated web platform, in accordance with an embodiment of the present invention, where FIG. 2A illustrates the identification of new customers through various queries and questionnaires, FIG. 2B illustrates the solicitation of an exemplary customer to the consumer for participation in an exemplary advertisement contest through various polls, FIG. 2C illustrates an exemplary customer initiating an exemplary advertising contest, FIG. 2D illustrates an exemplary login page for participating in an exemplary advertising contest, FIG. 2E illustrates an exemplary terms and conditions form generated for participating in an exemplary advertisement contest, FIG. 2F illustrates an exemplary consumer submitting an exemplary video advertisement, FIG. 2H illustrates processing and analyzing of exemplary consumer media, FIG. 2G illustrates exemplary consumer media stored on an exemplary media storage portion, FIG. 2I illustrates a graphical representation of consumer media that an exemplary customer may accept or decline for public viewing, and FIG. 2J illustrates a plurality of consumer media that are marked as accepted or denied for public viewing. In the present invention, the marketing method and system 200 may include a method and system that utilizes a dedicated web platform for engaging the consumer in the marketing process, including, without limitation, initiating an advertisement contest by a producer, receiving and processing consumer media often in the form of video advertisements produced by the consumer, and optimizing participation in the advertising contest. In some embodiments, the consumer may initiate the marketing system and method. The consumer may initiate recommendations, requests, and nominations through various means, including, without limitation, direct calling, email request, or filling out request fields on an online website. The consumer input may be efficacious for suggesting specific products, ideas, services, or businesses in which they consumer desires to experience media advertisements. In this manner, producers with known locations may be automatically geo-located on an interactive map 202 located on a marketing system and method web page. The consumers may click on the interactive map and determine the geographic location of all of the producers and businesses for which the consumer would like to see advertisements produced. This allows the consumer to view the producers in their geographic proximity which are participating in media contests, and to determine if any additional producers in that area should be solicited. In some embodiments, the marketing system and method may include a dedicated platform for hosting videos.

In one embodiment of the present invention, each product or service recommendation made by the consumer may be entered into a media storage portion with the opportunity for viewers to agree that advertisements be made for a product. The media storage portion may include, without limitation, a visual database, a server, and a cloud. In one embodiment, the advertisement may be accessed through an “ads you want to see” tab by clicking on a “suggestions to date link.” Those skilled in the art, in light of the present teachings, will recognize that the number of voting consumers that agree to a particular product may be automatically tallied using software that ranks advertisements in appearance where by the highest number of yes votes automatically transitions that product or service to the top of the list. An advertisement tally graph 204 may provide a visual representation of the most popular advertisements. In some embodiments, contact with producers may be made through traditional channels, including, without limitation, telephone, postal mail, and in person solicitation.

In one embodiment of the present invention, the consumer may fill out a terms and conditions form prior to participating in the advertising contest from a marketing method and system home page 206. For example, without limitation, upon a solicitation to a potential customer to generate an advertising contest for the product or service, the consumer may be instructed to visit a website to begin the process of generating a contract. The first part of this process may include clicking a “Create Contest” button. In some embodiments, clicking the Create Contest button may actuate a login page. The consumer may then be required to hold an account to initiate the advertising contest. In some embodiments, if the consumer already has an account, the consumer may input login information into form fields to access a prior account. However in other embodiments, if the consumer does not have an account, the consumer may be required to click a “Register Here” button on a registration portion 208 of the web page, whereby the consumer may be sent to yet another web page to sign up for an account by submitting required information into form fields. In some embodiments, upon signing up for the advertising contest, an email may be automatically sent to the consumer's listed email address. The consumer may further be required to verify personal information through a verification link sent in the email. In some embodiments, once an account was verified by the producer and the marketing expert, the consumer may have the opportunity to customize the profile with several options including picture thumbnail, and following sections that link to other social media channels.

In one embodiment of the present invention, the consumer may initiate the advertising contest from a home page by clicking on a “Launch Contest” button. Upon clicking the Launch Contest link, the consumer may be instructed to fill out three sequential form fields. A first form field may be utilized to gain a better understanding of the producer, including point of contact information. The next form field may need to be completed for identifying the terms and conditions of the specific contest, including, without limitation a set of questions that must be completed in order to generate a contract agreement. The set of questions may be beneficial for choosing a name for the contest, allowing consumers to comment on video option, submission time periods, voting period, results date, and a services level option, each with a specific price. A series of options may be available for the consumer to select from. The options may include a unique set of terms and conditions which specify the level of service and support by the marketing method and system during the advertising contest. Varying levels of support may be based on differences in advertising packages including, without limitation, level of outreach for advertising development, collection, processing and review of a certain number of ads, hosting of an approved number of ads on VoteMyAd and other various internet domains, and facilitation of the advertising contest including personalized service and customer follow-up. In some embodiments, ratification of the terms and conditions contract may be completed by clicking on an “Accept all terms and conditions” button and then submitting the contract through the internet.

In one embodiment of the present invention, upon ratification of the contract, the advertising contest may be automatically posted on the internet under a Contests page. In some embodiments, all advertising contests produced by the marketing expert may be found using various search terms including, without limitation, prize level, featured section, various sort options, and location. Information included in the advertising contest announcement may automatically populate the media storage portion based on the form fields and information provided that were provided in the terms and conditions of the contract that filled in by the consumer. In some embodiments, the advertising contest announcement may be made publicly viewable in various social media platforms, including, without limitation, Facebook, Twitter, YouTube, and Dig. The information pertinent to the advertising contest announcement may include, without limitation, video criteria such as length and promotional guidelines, prize categories and amounts, timeline for submitting video, date in which contest will start, contest duration, criteria for award winners, and terms and conditions for receiving an award.

In one embodiment of the present invention, the consumer may submit the consumer media by clicking on a “Submit Video” button in a media submission portion 210. The consumer media may be prescreened by the producer and the marketing expert, and then returned to the consumer account for final approval. In one embodiment, a contest selection portion 212 may allow the consumer to participate in a desired contest. The contest selection portion may be actuated by clicking on a current contest. A media storage portion 214 may display consumer media that has, or has not been approved by the producer and the marketing expert. Those skilled in the art, in light of the present teachings will recognize that upon acceptance or rejection of consumer media by the producer, pre-formatted consumer media may be uploaded under a ‘Current Ad Contests’ section for public viewing. A tally of all accepted and declined consumer media may be stored in the media storage portion. In some embodiments, the producer may better understand the consumer through study of the submitted consumer marketing videos. Suitable information gathered on the consumer may include, without limitation who is the target market based on age, size, social or geological location, which elements of the brand/product are most engaging, and what is the consumer perception of the brand image.

In one embodiment of the present invention, the consumer media posted to the internet, after being approved, may initially be posted to YouTube and imbedded in the marketing method and system website. A consumer media query portion 216 may graphically display all the consumer media that the consumer may have posted on various sites. In some embodiments, all views and shares may be tracked independently from the web site. The consumer media producers and viewers may be provided with various web coding text that facilitates posting videos and links to other internet platforms including, without limitation, Facebook, twitter, MySpace, yelp, and personal YouTube channels. In some embodiments, the links may imbed the videos in other social channels based from YouTube and VoteMyAd. All subsequent views, shares, and comments may then be counted and tallied within YouTube and the marketing method and system website. In this manner, the marketing method and system may provide a dedicated video social platform that is predicated on advertising contests that incentivize participation with cash and other prizes.

In one embodiment of the present invention, the same coding methods and use of triggers which may be utilized to share and post videos on internet social sites, may be utilized to promote the consumer media content in existing client marketing channels. For example, without limitation, when views on a consumer media reach 15,000 views, a trigger may be actuated. The trigger may automatically send the consumer media to the consumer's personal Facebook, MySpace, or Twitter notice. In this manner, targeting may be streamlined to the existing consumer base. In some embodiments, all of the consumer media submitted may be stored in the media storage portion. A number of searchable features may be used to find relevant consumer media of interest. In some embodiments, the chief search features may include, without limitation, number of views, most likes, and number of shares. Each of these categories may be searchable using chronology parameters, including, without limitation, this week, this month, this year, and all time. In one embodiment, the marketing method and system may be functional to collect geo and demographic data on consumer viewing patterns. The collection of data may include, without limitation, how many unique viewers are watching videos, on average how many videos does a person watch in a given day, how long a person watches for, which advertisements are most effective in terms of number of views, likes, which videos are favored in which geographic locations, and which videos/advertisements are well received by specific social demographics as defined by most views. In this manner, the marketing method and system provide specific viewing triggers which initiate a marketing media to be transmitted to specific videos that are produced to specific social and demographic groups. For example, without limitation, the media storage portion may specify that a certain video may be viewed and shared more in one demographic than another. The trigger may be based on video keywords, length, and location, to actuate the marketing media to the consumer.

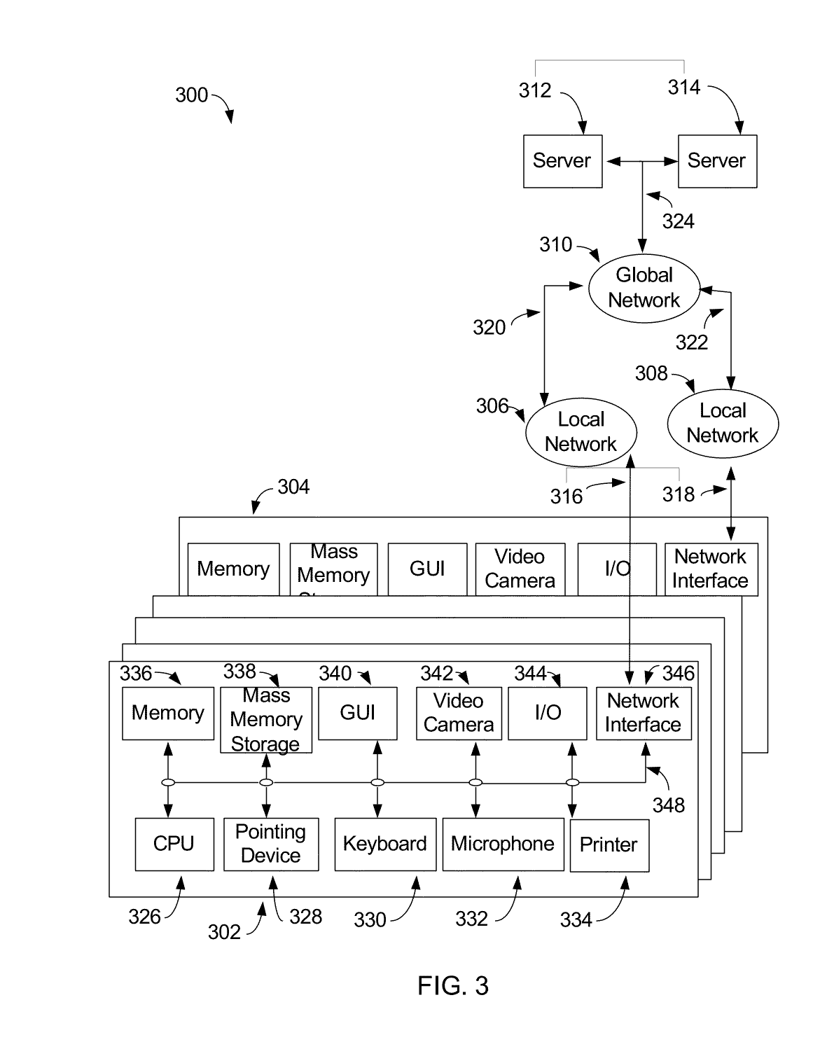

FIG. 3 illustrates a typical computer system that, when appropriately configured or designed, can serve as an exemplary marketing method and system, in accordance with an embodiment of the present invention. In the present invention, a communication system 300 includes a multiplicity of clients with a sampling of clients denoted as a client 302 and a client 304, a multiplicity of local networks with a sampling of networks denoted as a local network 306 and a local network 308, a global network 310 and a multiplicity of servers with a sampling of servers denoted as a server 312 and a server 314.

Client 302 may communicate bi-directionally with local network 306 via a communication channel 316. Client 304 may communicate bi-directionally with local network 308 via a communication channel 318. Local network 306 may communicate bi-directionally with global network 310 via a communication channel 320. Local network 308 may communicate bi-directionally with global network 310 via a communication channel 322. Global network 310 may communicate bi-directionally with server 312 and server 314 via a communication channel 324. Server 312 and server 314 may communicate bi-directionally with each other via communication channel 324. Furthermore, clients 302, 304, local networks 306, 308, global network 310 and servers 312, 314 may each communicate bi-directionally with each other.

In one embodiment, global network 310 may operate as the Internet. It will be understood by those skilled in the art that communication system 300 may take many different forms. Non-limiting examples of forms for communication system 300 include local area networks (LANs), wide area networks (WANs), wired telephone networks, wireless networks, or any other network supporting data communication between respective entities.

Clients 302 and 304 may take many different forms. Non-limiting examples of clients 302 and 304 include personal computers, personal digital assistants (PDAs), cellular phones and smartphones.

Client 302 includes a CPU 326, a pointing device 328, a keyboard 330, a microphone 332, a printer 334, a memory 336, a mass memory storage 338, a GUI 340, a video camera 342, an input/output interface 344 and a network interface 346.

CPU 326, pointing device 328, keyboard 330, microphone 332, printer 334, memory 336, mass memory storage 338, GUI 340, video camera 342, input/output interface 344 and network interface 346 may communicate in a unidirectional manner or a bi-directional manner with each other via a communication channel 348. Communication channel 348 may be configured as a single communication channel or a multiplicity of communication channels.

CPU 326 may be comprised of a single processor or multiple processors. CPU 326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 336 is used typically to transfer data and instructions to CPU 326 in a bi-directional manner. Memory 336, as discussed previously, may include any suitable computer-readable media, intended for data storage, such as those described above excluding any wired or wireless transmissions unless specifically noted. Mass memory storage 338 may also be coupled bi-directionally to CPU 326 and provides additional data storage capacity and may include any of the computer-readable media described above. Mass memory storage 338 may be used to store programs, data and the like and is typically a secondary storage medium such as a hard disk. It will be appreciated that the information retained within mass memory storage 338, may, in appropriate cases, be incorporated in standard fashion as part of memory 336 as virtual memory.

CPU 326 may be coupled to GUI 340. GUI 340 enables a user to view the operation of computer operating system and software. CPU 326 may be coupled to pointing device 328. Non-limiting examples of pointing device 328 include computer mouse, trackball and touchpad. Pointing device 328 enables a user with the capability to maneuver a computer cursor about the viewing area of GUI 340 and select areas or features in the viewing area of GUI 340. CPU 326 may be coupled to keyboard 330. Keyboard 330 enables a user with the capability to input alphanumeric textual information to CPU 326. CPU 326 may be coupled to microphone 332. Microphone 332 enables audio produced by a user to be recorded, processed and communicated by CPU 326. CPU 326 may be connected to printer 334. Printer 334 enables a user with the capability to print information to a sheet of paper. CPU 326 may be connected to video camera 342. Video camera 342 enables video produced or captured by user to be recorded, processed and communicated by CPU 326.

CPU 326 may also be coupled to input/output interface 344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 326 optionally may be coupled to network interface 346 which enables communication with an external device such as a database or a computer or telecommunications or internet network using an external connection shown generally as communication channel 316, which may be implemented as a hardwired or wireless communications link using suitable conventional technologies. With such a connection, CPU 326 might receive information from the network, or might output information to a network in the course of performing the method steps described in the teachings of the present invention.

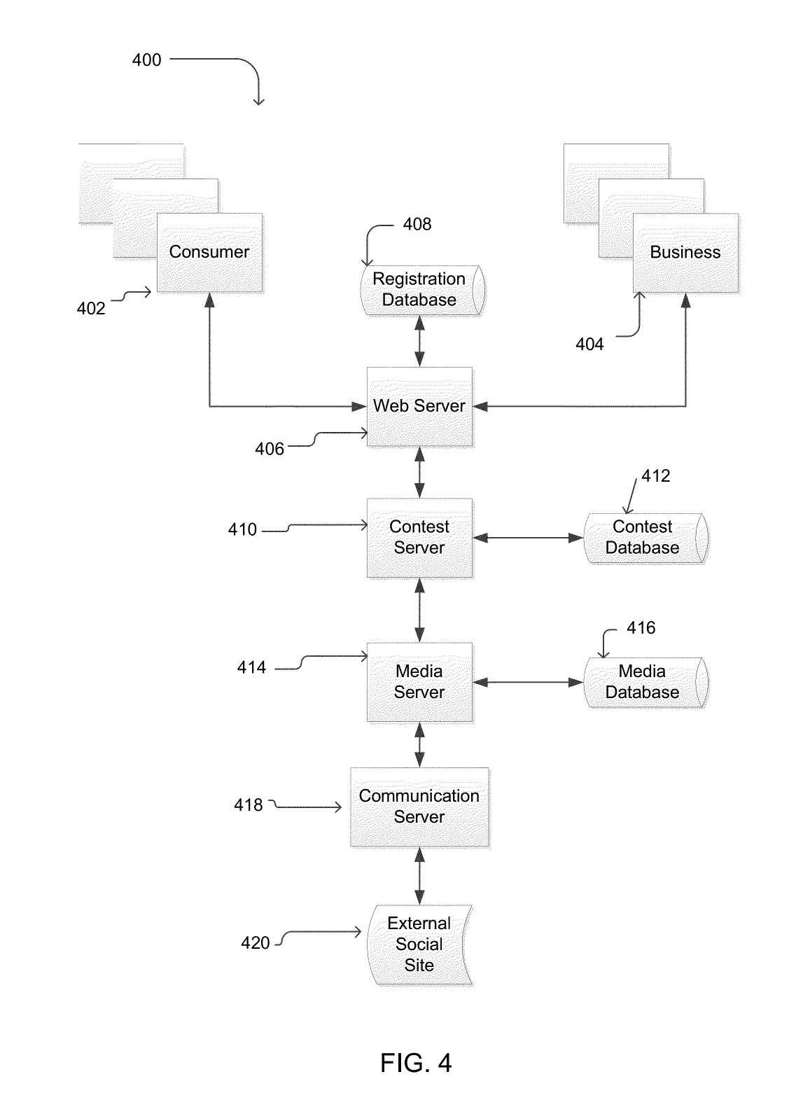

FIG. 4 illustrates an exemplary marketing system, in accordance with an embodiment of the present invention. In system 400, consumer 402 and business 404 communicate with web server 406. Web server 406 is configured for hosting marketing media from the producers and marketing experts of business 404. Web server 406 communicates, to at least one consumer, marketing media for at least one product for viewing by the consumer. The marketing media at least comprises a solicitation for an advertizing contest for the product. Web server 406 receives at least one consumer media produced by the consumer in response to the solicitation. In alternate embodiments, multiple consumers may combine efforts to produce the consumer media. In other alternate embodiments, multiple businesses may combine products in one marketing campaign. Consumer 402 and business 404 may register with marketing system 400. Web server 406 may store registration information in registration database 408. Consumer 402 and business 404 may transfer media to web server 406. Media server 414 may format and store transferred media in media database 416. Contest server 410 may administer contests for marketing system 400 and store contest information in contest database 412. Contest server 410 stores the consumer media in contest database 412 for approval by the producer and marketing expert and communicates an approval of said consumer media for further approval by the consumer for public viewing. Media server 414 stores the approved consumer media in media database 416 accessible by the public to search, view, comment, vote, and distribute the consumer media. Communication server 418 may transfer media files to an external social site 420. Web server 406 is further configured for receiving a profile for the consumer for storage. The profile being viewable and searchable by the producer and marketing expert. Contest server 410 is further configured for converting the consumer media into a single format enabling the consumer content to be linked to other media. Contest server 410 is further configured for inspecting the consumer media for compliance with terms and conditions of the advertizing contest. Contest server 410 is further configured for determining participant information and site location information for the consumer media. The information is stored on contest database 412 and accessible by the producer and marketing expert. Contest server 410 is further configured for maintaining a tally of all approved and rejected consumer media. The tally is stored on contest database 412. Media server 414 is further configured for compiling metrics for the public's engagement of the consumer media. The metrics are stored on contest database 412 and accessible by the producer and marketing expert. The communication to the external social sites 420 is triggered by a metric comprising a number of views of the consumer media by the public. Communication server 418 is further configured for communicating metrics associated with popularity of consumer media to members of the public.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: including the consumer in the marketing process.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing marketing with consumer generated advertising contests according to the present invention will be apparent to those skilled in the art. Various aspects of the invention have been described above by way of illustration, and the specific embodiments disclosed are not intended to limit the invention to the particular forms disclosed. The particular implementation of the marketing with consumer generated advertising contests may vary depending upon the particular context or application. By way of example, and not limitation, the marketing with consumer generated advertising contests described in the foregoing were principally directed to distributing marketing media to a consumer who submits a publicly viewable production of a consumer media, often in the form of a video advertisement implementations; however, similar techniques may instead be applied to marketing on radio, whereby the consumer sends a musical advertisement, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method comprising the steps of:
communicating with a computer system being at least configured to host marketing media from at least one producer and marketing expert;
receiving, from said system, marketing media for at least one product for viewing by a consumer, said marketing media at least comprising a solicitation for an advertizing contest for the product;
transferring, to said system, at least one consumer media produced by said consumer in response to said solicitation, said system storing said consumer media in a first database for approval by said producer and marketing expert;
receiving, from said system, an approval of said consumer media for further approval by said consumer for public viewing; and
transferring, to said system, said approval by said consumer for public viewing, said system storing said approved consumer media in a second database viewable and searchable by the public, viewing of said consumer media at least in part determining an outcome of said advertizing contest.

2. The method as recited in claim 1, further comprising the step of transmitting, to said system, a profile for said consumer, said system storing said profile to be viewable and searchable by said producer and marketing expert.

3. The method as recited in claim 1, in which said consumer media is inspected for compliance with terms and conditions of said advertizing contest.

4. The method as recited in claim 1, in which the public accesses said second database to search, view, comment, vote, and distribute the consumer media.

5. The method as recited in claim 1, in which said system converts said consumer media into a single format enabling said consumer content to be linked to other media.

6. The method as recited in claim 1, in which said system compiles metrics for the public's engagement of said consumer media, said metrics being stored on said first database and accessible by said producer and marketing expert.

7. The method as recited in claim 1, in which said system collects geographic and demographic data on the public's viewing patterns of said consumer media, said data being stored on said first database and accessible by said producer and marketing expert.

8. The method as recited in claim 1, in which said system determines participant information and site location information for said consumer media, said information being stored on said first database and accessible by said producer and marketing expert.

9. The method as recited in claim 1, in which said system communicates said consumer media in said second database to external social sites.

10. The method as recited in claim 9, in which said communication is triggered by a metric associated with said consumer media.

11. The method as recited in claim 10, in which said metric comprises a number of views of said consumer media by the public.

12. The method as recited in claim 1, in which said system is further configured for hosting marketing media from a plurality of producers and marketing experts.

13. The method as recited in claim 12, in which said system is further configured to receive a plurality of consumer media from a plurality of consumers.

14. The method as recited in claim 13, in which said system maintains a tally of all approved and rejected consumer media, said tally being stored on said first database.

15. The method as recited in claim 1, in which said system comprises a dedicated platform for hosting consumer media to the public.

16. The method as recited in claim 1, in which said system communicates metrics associated with popularity of consumer media to members of the public.

17. A method comprising:
steps for communicating with a computer system being at least configured to host marketing media;
steps for receiving marketing media for viewing by a consumer;
steps for transferring at least one consumer media produced by the consumer;
steps for receiving an approval of said consumer media for further approval by said consumer for public viewing; and
steps for transferring said approval by said consumer for public viewing in which viewing of said consumer media at least in part determining an outcome of said advertizing contest.

18. The method as recited in claim 17, further comprising steps for transmitting a profile for the consumer.

19. A system comprising:
a web server being configured for communicating with consumers and producers and marketing experts for hosting marketing media from the producers and marketing experts, said web server being further configured for communicating, to at least one consumer, marketing media for at least one product for viewing by the consumer, the marketing media at least comprising a solicitation for an advertizing contest for the product, said web server being further configured for receiving at least one consumer media produced by the consumer in response to the solicitation;
a first database;
a contest server being configured for at least storing the consumer media in said first database for approval by the producer and marketing expert and communicating an approval of said consumer media for further approval by the consumer for public viewing;
a second database;
a media server being configured for storing the approved consumer media in said second database accessible by the public to search, view, comment, vote, and distribute the consumer media, accessing of the consumer media at least in part determining an outcome of the advertizing contest, said media server comprising a dedicated platform for hosting consumer media to the public; and
a communication server being configured for communicating the approved consumer media to external social sites.

20. The system as recited in claim 19, in which said web server is further configured for receiving a profile for the consumer for storage, the profile being viewable and searchable by the producer and marketing expert, said contest server is further configured for converting the consumer media into a single format enabling the consumer content to be linked to other media, said contest server is further configured for inspecting the consumer media for compliance with terms and conditions of the advertizing contest, said contest server is further configured for determining participant information and site location information for the consumer media, the information being stored on said first database and accessible by the producer and marketing expert, said contest server is further configured for maintaining a tally of all approved and rejected consumer media, the tally being stored on said first database, said media server is further configured for compiling metrics for the public's engagement of the consumer media, the metrics being stored on said first database and accessible by the producer and marketing expert, the communication to the external social sites is triggered by a metric comprising a number of views of the consumer media by the public, the communication server is further configured for communicating metrics associated with popularity of consumer media to members of the public.
